(19) United States
(12) Patent Application Publication
(10) Pub. No.: US 2010/0064367 A1
(43) Pub. Date: Mar. 11, 2010

(54) INTRUSION DETECTION FOR COMPUTER PROGRAMS

(75) Inventor: Tore Lysemose Hansen, Oslo (NO)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: UNIVERSITETET I OSLO, Oslo (NO)

(21) Appl. No.: 11/815,288

(22) PCT Filed: Jan. 30, 2006
(86) PCT No.: PCT/GB2006/000304

§ 371 Date: Aug. 25, 2009

(30) Foreign Application Priority Data
Feb. 2, 2005 (NO) 20050564

(51) Int. Cl. G06F 21/00; G06F 11/00

(52) U.S. Cl. 726/23

(57) ABSTRACT

A method of detecting intrusion in a computer program which has number of defined libraries and includes cross border instructions which cause execution to branch from a source library to a target library. The method comprises the step of determining whether execution of the program is in an area consistent with normal execution of the program, by checking whether the source library of a cross border instruction is the expected current execution library of the program. Each cross border instruction has a code stub identifying the source library, and when a legal cross border instruction is executed the target library becomes the current execution library. The method also checks that the target address of a cross border instruction is a legal address. In another arrangement, areas of the program are set so that a cross border instruction will generate page protection fault which is intercepted by the intrusion detection system so that the cross border instruction can be checked.

The present invention relates to an intrusion detection system for computer programs. The invention is particularly but not exclusively concerned with a host based intrusion detection system for detecting control flow attacks on programs running on data processing systems connected to a network.

Data processing systems connected to a network, and particularly a publicly accessible network such as the internet, are vulnerable to remote attacks. When such remote attacks are automated, the result may be rapidly spreading worms capable of infecting a large number of systems, on a worldwide basis. In recent years there have been several instances of this type of attack, such as the SQL-Slammer and Blaster worms in 2003 and the Sasser worm in 2004

Frequently, such attacks are control flow attacks on programs. A control flow is a succession of instructions being executed by a program. A control flow attack is where an attacker takes control of the succession of instructions being executed.

In normal running of a program, when most instructions in a control flow are executed, a following instruction is automatically executed next. However, control flow instructions may also cause execution to jump to instructions further away, for example call, return and branch/jump instructions. The processor knows which instruction to jump to from information stored in a program address, a code pointer, which is examined at execution. In some cases the stored program address is part of the instruction itself, but in other cases the program address is stored elsewhere, for example in a memory cell in an area of memory containing data rather than the program instructions.

If a memory cell containing a stored program address is not write-protected, then an attacker may be able to overwrite the stored program address, for example by means of a buffer overflow with a completely arbitrary address, and in this way gain control of the execution. The attacker may for example overwrite the stored program address with the address of a dangerous function such as “format hard disk” or with the address of some code that the attacker might have managed to inject into the address space of the program. In an “existing code attack” the changed code pointer points to a location containing an instruction belonging to the program. In an “injected code attack” the code pointer points, at some time during the attack, to a location containing an instruction which is not a program instruction. In either situation, the control flow of the program deviates from the normal flow and damage can be done.

One way to overwrite memory locations is by overflowing a buffer. A buffer is a finite, continuous data area in memory. In some programming languages, there are functions that do not check the size of the buffer before data is copied into it. One example is the C “strcpy” function. Since buffer size checking is not automatically done, it is up to the programmer to do the necessary checks before data is copied into the buffer. Unfortunately this is often forgotten. Depending on the location of the data buffer, a buffer overflow has different effects. A buffer overflow in a data area of the program may corrupt the state of the program data but have no further effect. A buffer overflow on the stack, on the other hand, has a high probability of affecting the control flow because the return addresses are situated there. Such a buffer overflow on the stack is often referred to as a return address attack, i.e. a code pointer value attack on a return instruction.

There are various known defence techniques for dealing with such threats, which can be broadly categorised as “Intrusion prevention” and “Intrusion detection”. Intrusion prevention techniques aim to prevent the intrusion from happening in the first place. These techniques range from installing firewalls to writing programs with fewer vulnerabilities. Unfortunately, firewalls are not particularly efficient in stopping attacks and the number of reported program vulnerabilities is rapidly increasing.

An intrusion detection system (IDS) monitors and analyses system events in order to provide real-time warnings of unauthorised attempts to access system resources. There are two basic types of IDS, namely “signature based” and “anomaly based”. Signature based systems look for signatures, i.e. patterns, of known malicious code, and are commonly used. A problem with such systems is that even a small variation in the attack code fools the IDS and another is that a new type of attack cannot be detected until the IDS has been updated with the new signature.

Anomaly based IDS's on the other hand can be good at detecting new attacks, but typically have problems with false alarms. Most anomaly based IDS's have to go through a learning phase during which they learn the normal behaviour of the program, but since it is impossible in practice to go through all possible execution paths in the training phase, the model of execution will be incomplete. This means that if at a later stage the program reaches a normal but rare state not covered by the model, the IDS will react as if it was an attack. Furthermore, most anomaly IDS's suffer from significant performance overheads, or conversely only offer a very limited protection.

Another problem with anomaly based IDS's is that they require access to the source code of the monitored programs. However, on many platforms, such as the Microsoft Windows™ platform, source code is not accessible.

One particular security mechanism is the “Shepherding Mechanism” developed by the Massachusetts Institute of Technology. This uses two main techniques for intrusion detection: namely “restricted control flow” and “sandboxing”. Both of these techniques are based on the concept of execution interception, in which instructions are copied to a code cache before they are executed and so consequently no instructions are executed outside the code cache. In the code cache normal (i.e. non-control flow) instructions are executed without interference by the shepherding mechanisms, but execution of all control flow instructions are intercepted by the mechanism, which checks whether the target instruction of the control flow instruction is a legal target. If the check is passed, execution continues at this target instruction at the code cache.

The execution of control flow instructions in the code cache is intercepted by replacing the instructions with jump instructions to the shepherding mechanism. If the legal target address of an instruction has been overwritten by an attacker, this will be detected by the shepherding mechanism provided that the legal target is known by the mechanism. Unfortunately on the Microsoft Windows™ platform source code is not often accessible and so the legal targets will not normally be known. Hence, in many cases, the shepherding mechanism is not able to detect illegal targets. Furthermore, this mechanism monitors all control flow instructions in the program and therefore has considerable memory and execution time overheads.

The sandboxing technique works by validating input parameters when a call to a sandboxed routine is intercepted. The shepherding monitor sandboxes one routine and allows only static arguments, i.e. arguments from write-protected memory.

Another known intrusion detection method is DOME, “Detection of injected, dynamically generated, and obfuscated malicious code”, Rabek et al, Proceedings of the 2003 ACM workshop on Rapid Malcode, October 2003. The DOME IDS is primarily intended for the Microsoft Windows™/Intel™ platform. It uses a combination of static binary code analysis and monitoring of routine calls to the Win32 API. A commercial disassembler tool, IDA, is used to identify the places in the code which execute calls to the Win32 API. During runtime, all calls to the Win32 API are intercepted using a tool called Detours. This patches the first instruction of a monitored routine with a jump instruction which transfers control to the DOME monitor by means of a small piece of intermediate code. DOME then uses the return address to identify the address of the instruction which initiated the call. If the call address does not belong to the set of legal addresses produced in the analysis phase, DOME signals a detection alarm.

However, DOME does not protect against attack calls using a branch to a call instruction in the program, or attacks which do not use the Win32 API or use it in an unusual way, as is the case with interior calls. Furthermore, if a standard C library (DLL) is present, it is quite easy to bypass the DOME monitor whilst keeping the call process easy to manage, by using the C library instead of the Win32 API directly.

Thus the DOME IDS does not detect indirect attack calls or interior attack calls. The shepherding mechanism does not detect attacks on call and branch instructions targeting instructions in the same library, although reasonable protection is provided by detecting attacks targeting routines in other libraries. The shepherding mechanism does not protect return instructions, since it does not detect interior call attacks on this type of instruction if the interior call targets an instruction following previously executed call instructions.

There is a need for an improved intrusion detection system which will provide a reasonable level of protection but with reduced overheads.

Viewed from one aspect, the present invention provides a method of detecting intrusion in a program running on a data processing system, the program having a number of areas and including normal cross border instructions which, during normal execution, cause program execution to move from a source area containing the cross border instruction to a target area; wherein:

(a) there is associated with each cross border instruction data indicating the source area of the cross border instruction;
(b) an intrusion detection system monitors the execution of cross border instructions;
(c) data is stored identifying a current execution area, being the target area of the most recently monitored cross-border instruction which was executed so that program execution was transferred to its target area;
(d) when a cross border instruction is executed, the intrusion detection system determines whether the source area of the instruction matches the current execution area.

If there has been no intrusion in the program and execution has been normal, the source area of a cross border instruction will be the stored current execution area, and the instruction will be executed in the normal way. If there has been intrusion in the program so that a non-border instruction has been changed so as to branch to another area, execution of that corrupted instruction will not be monitored by the intrusion detection system because it is not a recognised cross border instruction. Accordingly, the stored current execution area will not match the area in which execution is actually taking place as a result of the intrusion. By comparing the stored current execution area with the actual area in which execution is taking place, the presence of an anomaly is detected and appropriate action can be taken if necessary.

In accordance with the invention, the existence of an anomaly is detected when there is a subsequent cross border instruction. That instruction, as such, may be perfectly valid but the intrusion detection system will detect that an anomaly has occurred. The comparison of the stored current execution area and the actual area of execution could take place at other times also, but in the preferred embodiment monitoring is only carried out in respect of normal cross border instructions. By monitoring only normal cross border instructions, processing overheads are significantly reduced.

An intrusion may also cause a recognised cross border instruction to branch to an illegal target in another area. Thus, preferably, the method of intrusion detection also includes the step of checking whether the target address of a cross border instruction is legal. If it is not, then intrusion is detected. Typically, this step could be carried out prior to the step of checking the source area of the instruction against the stored current execution area. If the target address is illegal, then in general execution will not be permitted, so there will be no need to check the current execution area.

Thus, in a preferred form the method directly detects attacks on recognised cross border instructions if the target is invalid, and also indirectly detects attacks that cause non-border instructions to branch to another area, by detecting an anomaly when there is a subsequent recognised cross border instruction. Accordingly, a significant level of intrusion detection is provided, whilst monitoring only some of the control flow instructions of the program, i.e. those which, during normal execution, cause execution to branch to another area. This is a significant improvement over prior art methods that require all control flow instructions to be checked in order to provide similar levels of protection. As such, embodiments of the present invention can provide considerably reduced execution time overheads in comparison with prior art methods. Preferred embodiments of the invention can provide a high protection level regardless of attack targets and attack call methods, with a significantly reduced risk of false alarms. The method of checking for current execution areas is not reliant on access to source code.

Viewed from another aspect, the invention provides data processing apparatus for executing a computer program, the program having a number of areas and including normal cross border instructions which, during normal execution, cause program execution to move from a source area containing the cross border instruction to a target area; wherein the apparatus is configured to provide an intrusion detection system for monitoring the execution of the cross border instructions, in which:

(a) there is associated with each cross border instruction data indicating the source area of the cross border instruction;
(b) data is stored identifying a current execution area, being the target area of the most recently monitored cross-border instruction which was executed so that program execution was transferred to its target area;
(c) when a cross border instruction is executed, the intrusion detection system determines whether the source area of the instruction matches the current execution area.

Viewed from another aspect, the invention provides a software product containing instructions which when run on data processing apparatus executing a computer program having a number of areas and including normal cross border instructions which, during normal execution, cause program execution to move from a source area containing the cross border instruction to a target area, will cause the apparatus to be configured to provide an intrusion detection system for monitoring the execution of the cross border instructions, in which:

(a) there is associated with each cross border instruction data indicating the source area of the cross border instruction;
(b) data is stored identifying a current execution area, being the target area of the most recently monitored cross-border instruction which was executed so that program execution was transferred to its target area;
(c) when a cross border instruction is executed, the intrusion detection system determines whether the source area of the instruction matches the current execution area.

The software product may be distinct from the program running on the apparatus, or may be incorporated in the program, so that the complete instructions cause the data processing apparatus to run both the basic program and the intrusion detection system.

Viewed from another aspect, the invention provides a method of modifying a computer program having a number of areas and including normal cross border instructions which, during normal execution, cause program execution to move from a source area containing the cross border instruction to a target area, the method including the step of modifying the computer program so that when the program is run on data processing apparatus the program will cause the apparatus to be configured to provide an intrusion detection system for monitoring the execution of the cross border instructions, in which:

(a) there is associated with each cross border instruction data indicating the source area of the cross border instruction;
(b) data is stored identifying a current execution area, being the target area of the most recently monitored cross-border instruction which was executed so that program execution was transferred to its target area;
(c) when a cross border instruction is executed, the intrusion detection system determines whether the source area of the instruction matches the current execution area.

Thus, in accordance with this aspect of the invention a basic computer program can be modified so that in use it will incorporate the intrusion detection system.

Viewed from another aspect, the invention provides a software product containing instructions which when run on data processing apparatus will cause the apparatus to execute a computer program having a number of areas and including normal cross border instructions which, during normal execution, cause program execution to move from a source area containing the cross border instruction to a target area, the software product instructions being such as to further configure the apparatus to provide an intrusion detection system for monitoring the execution of the cross border instructions, in which:

(a) there is associated with each cross border instruction data indicating the source area of the cross border instruction;
(b) data is stored identifying a current execution area, being the target area of the most recently monitored cross-border instruction which was executed so that program execution was transferred to its target area;
(c) when a cross border instruction is executed, the intrusion detection system determines whether the source area of the instruction matches the current execution area.

The data processing apparatus will typically comprise one or more of a processor, volatile memory, non-volatile memory, an input device such as a mouse or keyboard and an output device such as a screen. The apparatus need not be a typical computer, such as a server, desktop personal computer, laptop and so forth. Other devices such as mobile telephones, personal digital assistants, and control units for machines, are also encompassed.

A computer software product in accordance with aspects of the invention may be supplied on portable physical media carrier such as a CD or DVD, may be supplied in the form of signals downloaded from a remote site, for example using the internet, or may be installed on permanent storage media within data processing apparatus, such as a hard disk. The software may be provided in an encrypted and/or compressed form, or another inoperative form, and an installation routine may be necessary to make the software operative. The software may be provided as an add-on to an existing software product.

The programs in respect of which intrusion detection takes place in accordance with the various aspects of the invention may be application programs or operating system programs or the like.

It will be appreciated that if relying only on checking cross border instructions and monitoring the current execution area, in accordance with the invention intrusion will not be detected where either a non-border instruction or a normal cross-border instruction is attacked and caused to continue execution in the same area (i.e. an “area-internal’ attack). Intrusion is also not detected where the attack causes a normally non-border instruction to call a routine from another area, if the routine is not normally called from the outside and does not cause the flow of execution to ever reach a recognised cross border instruction. This is because the data stored which indicates the current area of execution will never be checked.

Preferably, therefore, the areas should be optimally selected so that an attack on a control-flow instruction is more likely to cause the instruction to target an instruction in another area rather than the same area. For example, instructions which are similar may be grouped into an area, since it may be less likely that an attack would cause an instruction to target another instruction similar to that which was correctly intended.

In safety-critical areas of the program, the area size could be made smaller. In this way, fewer instructions will be in each area and therefore more area borders will be crossed than if the areas were larger. As such, fewer undetectable “area-internal” attacks are likely to occur.

For routines which do not ever cause the flow of execution to reach a valid cross border instruction, an artificially created separate area could be dedicated to each such routine so that the routine cannot be called other than by a cross-border instruction.

Of course, by having smaller areas, there would inevitably be more recognised cross-border instructions, and so more checks would need to be carried out. This would increase the performance overhead. A balance should therefore be struck between the level of detection and the performance overheads. Hypothetically, at an extreme, an area could be so small that all control flow instructions are monitored.

That is not in accordance with the aims of the invention and thus in general an area will contain a plurality of control flow instructions, at least one of which is a cross border instruction and at least one of which is an internal control flow instruction.

In one embodiment, areas are sets of routines, i.e. area borders follow the borders between routines. When the method is carried out on the Microsoft Windows™ platform, the areas may be constituted by modules, or the libraries of the program.

It is most desirable to detect attacks on instructions which change the system state. Therefore instructions which only change the local state of a program are less significant, and could be ignored in order to reduce performance overhead without significantly changing the protection level. Such instructions can be identified by performing analysis of assembler code of the libraries.

This concept of ignoring certain instructions can be extended to the idea of distinguishing between security relevant and security-irrelevant “system state”. For example, system state related to GUI functionality could be regarded as security irrelevant, and consequently instructions related to change in GUI could be ignored.

The instructions which, during normal execution may cause execution to branch to another area, can be determined in a number of different ways. In an embodiment wherein area borders follow routine borders, an area border will normally only be crossed in case of execution of a call or return instruction. Thus, a valid cross border instruction is either a call instruction which has a legal target in another area, or a return instruction if a call instruction exists in another area, which may legally call the routine containing the return instruction. Therefore in this embodiment, such border instructions are identified and monitored.

The step of checking whether the target address of a valid cross border instruction is legal will depend on the type of instruction and how the areas are defined. In one embodiment, if the instruction is a call instruction, the crossing is legal if the target address belongs to the set of legal addresses of the call instruction. Alternatively, if the instruction is a return instruction, the return instruction should target the instruction following the call. Preferably, a global stack of return addresses is kept and updated on every area entry and exit. Hence, the return from the area should target the address on top of the address stack, and this can be checked. If the border crossing is determined not to be legal, then intrusion is detected.

According to the method of the invention, the intrusion detection system provides an indication that intrusion may have taken place in suitable cases. This indication may be passed to the user of the program, for example by way of a pop-up message, or may be used for example to terminate the program is automatically. Steps may be taken to identify the origin of the attack.

In one embodiment, the method of the present invention is implemented using a software module which is injected into the address space of the monitored program. In the case of implementing the method on the Windows™ platform, the module may be injected into running GUI programs using Windows Hooks.

The module also preferably contains interception functionality to intercept valid cross-border instructions and perform the check to determine whether data which has been stored identifying the area to which program execution previously validly branched matches the source area of the valid cross border instruction.

It is envisaged that such a module may be supplied separately to the program it is monitoring, the module being configured to insert itself into a program chosen by a user. Alternatively, a program may be supplied having such a module incorporated within it.

The invention may be viewed from various different aspects. For example, viewed from another aspect, the invention provides a method of detecting intrusion in a program executing on data processing means, the program having a number of defined areas and including cross border instructions which cause execution to branch from a source area containing the cross border instruction to a target area; wherein:

(a) data is stored which is indicative of a valid current execution area;
(b) a cross border instruction which is identified as being a valid cross border instruction is processed by an intrusion detection system; a check is carried out that the source area of the cross border instruction is the valid current execution area, and data is stored which indicates that the valid current execution area has changed to the target area of that cross border instruction; and wherein
(c) the intrusion detection system is such that if an instruction which through intrusion in the program causes execution to branch from a source are containing the instruction to a target area, but that instruction is not identified as being a valid cross border instruction, that instruction will not be processed by the intrusion detection system and the data indicative of the valid current execution area will be unchanged; whereby if there is a subsequent cross border instruction from the target area which is identified as being a valid cross border instruction, the intrusion detection system will detect that the source area does not correspond to the valid current execution area.

Viewed from another aspect the invention provides a method of detecting intrusion in a program running on a data processing means, the program comprising a number of areas and valid cross border instructions which, during normal execution in the absence of intrusion cause program execution to branch from a source area containing the valid cross border instruction to a target area; wherein:

(a) when such a valid cross-border instruction is executed, an intrusion detection system performs a check to determine whether data which has been stored identifying the area which was the target of the last monitored valid cross border instruction matches the source area of the current valid cross border instruction;
(b) if the stored data does match the source area of the current valid cross border instruction, then the intrusion detection system stores data identifying the target area to which instructions have branched; or
(c) if the stored data does not match the source area of the current valid cross border instruction, then the intrusion detection system provides an indication that intrusion may have taken place.

Viewed from another aspect the invention provides a method of detecting intrusion in a program executing on data processing means, the program having a number of defined areas and including cross border instructions which cause execution to branch from a source area containing the cross border instruction to a target area; wherein the method comprises the step of determining whether execution of the program is in an area consistent with normal execution of the program. Such a method may comprise the additional step of monitoring whether the target address of a cross border instruction is legal.

It will be appreciated that in the preferred embodiments of the invention, simple control flow instructions which result in execution in the same area, are not monitored.

In general, only normal cross border instructions, or cross border instructions recognised as being normal cross border instructions, are monitored. However, some embodiments of the above aspects of the invention, and embodiments in accordance with other aspects of the invention, may monitor all cross border instructions.

A further aspect of the invention relies upon using the operating system functionality related to virtual memory (VM) management, whilst still using the concept of dividing the program into areas and monitoring cross border instructions. Given that the program is divided into defined areas (e.g. the program modules), it is possible to implement a detection method based on the VM management. In such an arrangement, the “current area” is the only area present in virtual memory.

If a border crossing occurs (legal or illegal), the page fault handler will be invoked (since a page fault occurs). This allows for checking whether the border crossing is legal or illegal. If the border crossing is legal, the source area of the border crossing will be “made invisible” by manipulating the setting of the virtual memory page (such that it seems to be “paged out”), and then the target area of the border crossing will be “made visible” (again by proper manipulating of VM settings).

Such an implementation would impose some restrictions on the area topology. In general it might only work if area borders, were “aligned” with virtual memory pages. Furthermore, executing reading and writing instructions should not, or should not necessarily, be restricted. Thus, if a page fault occurs due to a read-instruction trying to read from another area than the current, then it should be allowed to do so. Only page-faults related to control flow instructions which are cross border crossing should be restricted.

Consequently, no execution of a control flow instruction making a jump inside the current area would be monitored. However, all jumps to a new area would cause the page fault handler, and hence the monitor, to be invoked.

This means that if an illegal border crossing occurs it will immediately be discovered. In the previous embodiments of the invention, and in accordance with some of the broad aspects of the invention, an illegal border crossing would be allowed, and would only be detected if at a later stage a normal border crossing occurred, in which case the source area of the normal border crossing would not be the expected area. In accordance with the proposed VM arrangement it is no longer essential to keep an variable containing the id of the “current area”, since there can be no mismatch between the current area of execution and the actual area of execution.

In accordance with this aspect of the invention, any execution jump to a new area will be a border crossing that is monitored.

Viewed from another aspect, the present invention provides a method of detecting intrusion in a program running on a data processing system, the program having a number of discrete program areas and comprising, in each discrete program area, instructions including at least one cross border instruction which, during execution, causes program execution to move from a source discrete program area containing the cross border instruction to a target discrete program area; wherein:

(b) a currently active discrete program area of the program is set so that memory pages have a level of protection which will allow execution within that currently active area without generation of a fault;
(b) other discrete program areas of the program are set so that memory pages have a level of protection which will generate a fault if there is an attempt to access those other areas;
(c) when a cross border instruction is encountered in the currently active area of the program, seeking to move program execution to a target in another discrete program area, the generation of the fault causes an intrusion detection system to determine whether the cross border instruction is valid.

In preferred embodiments of this aspect of the invention, if the cross border instruction is valid, the currently active discrete program area of the program is set so that memory pages have a level of protection which will generate a fault if there is an attempt to access that area; and the other discrete program area containing the target of the cross border instruction is set so that memory pages have a level of protection which will allow execution within that other area without generation of a fault.

In preferred embodiments of this aspect of the invention, if a cross border instruction is not a control flow instruction but is seeking to read data in another discrete program area, the other discrete program area containing the target of the cross border instruction is set temporarily so that memory pages have a level of protection which will allow reading of data within that other area without generation of a fault; and after reading of the data that other program area is set so that memory pages have a level of protection which will generate a fault if there is an attempt to access those other areas.

It will be seen that embodiments in accordance with this aspect of the invention and other aspects of the invention rely upon dividing a program into discrete program areas, and only monitoring control flow instructions which seek to transfer execution from one discrete program area to another.

Thus viewed from another aspect the invention provides a method of detecting intrusion in a program running on a data processing system, the program having a number of discrete program areas and comprising, in each discrete program area, control flow instructions including at least one cross border instruction which, during execution, causes program execution to move from a source discrete program area containing the cross border instruction to a target discrete program area; wherein an intrusion detection system monitors only control flow instructions which are cross border instructions.

Such an intrusion detection system could be used in conjunction with other systems that monitor other aspects, but as such it does not monitor control flow instructions which only control execution within a discrete program area.

It will be appreciated that for the methods in accordance with the various aspects of the invention, there are equivalent aspects relating to computer software products, data processing apparatus and systems, and so forth. It will also be appreciated that there may be other aspects of the invention setting out novel features and combinations of features of the systems described in this specification.

Preferred embodiments of aspects of the present invention will now be described by way of example only and with reference to the accompanying drawings, in which:

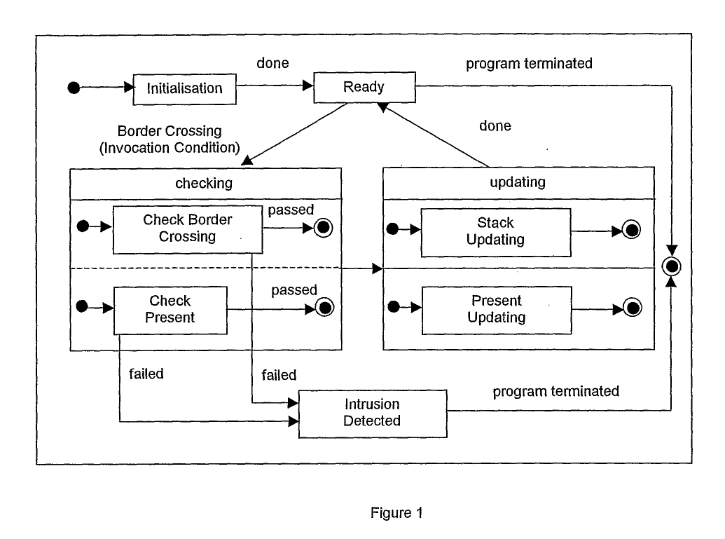

FIG. 1 is a state machine diagram of a method in accordance with the invention;

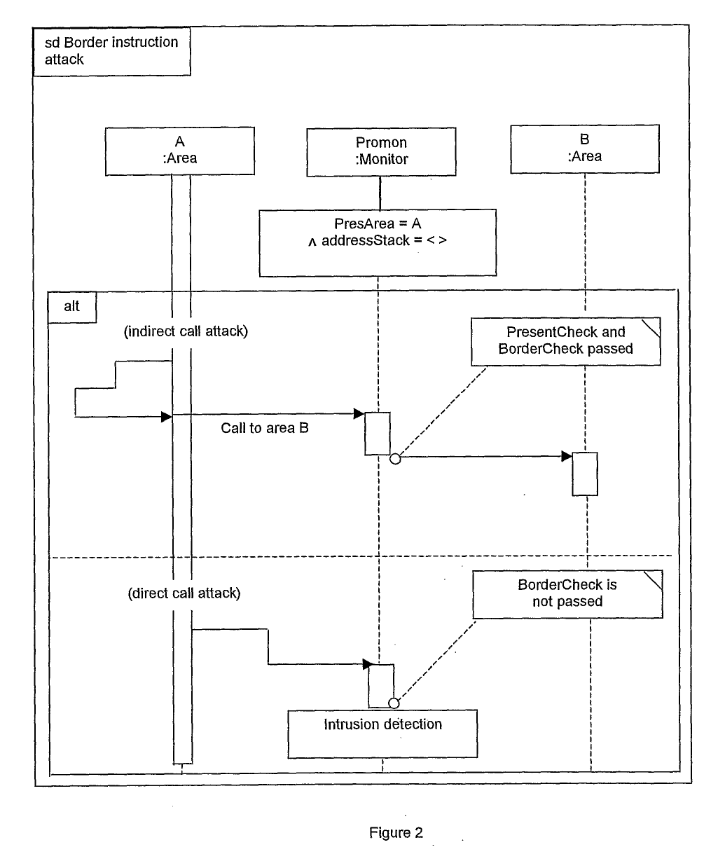

FIG. 2 is a sequence diagram illustrating an intrusion on a cross border instruction;

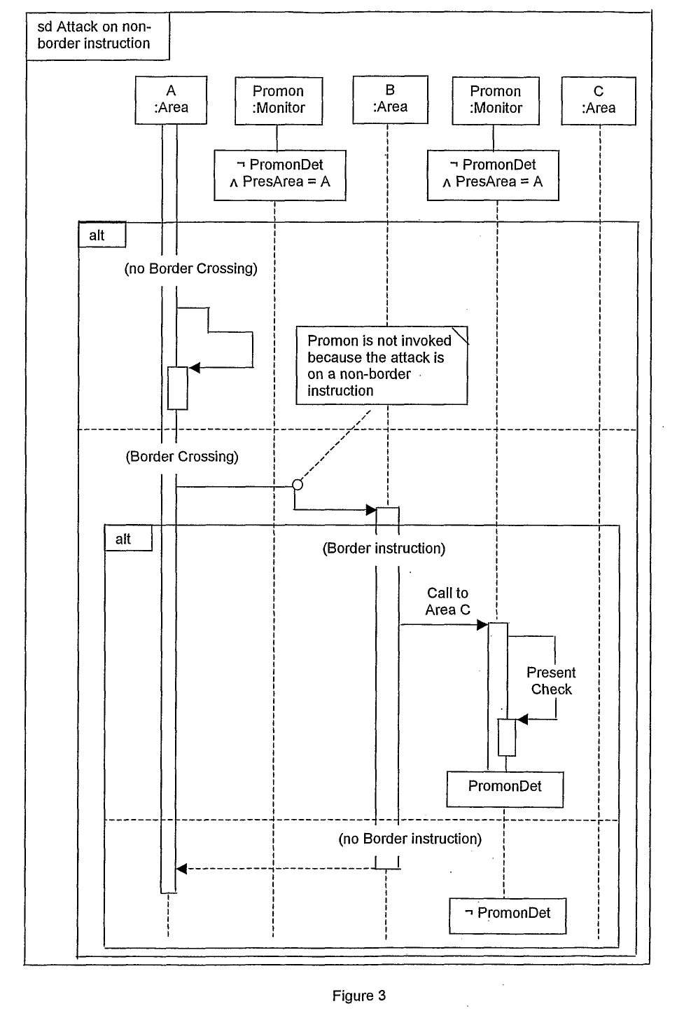

FIG. 3 is a sequence diagram illustrating an intrusion on a non-cross border instruction;

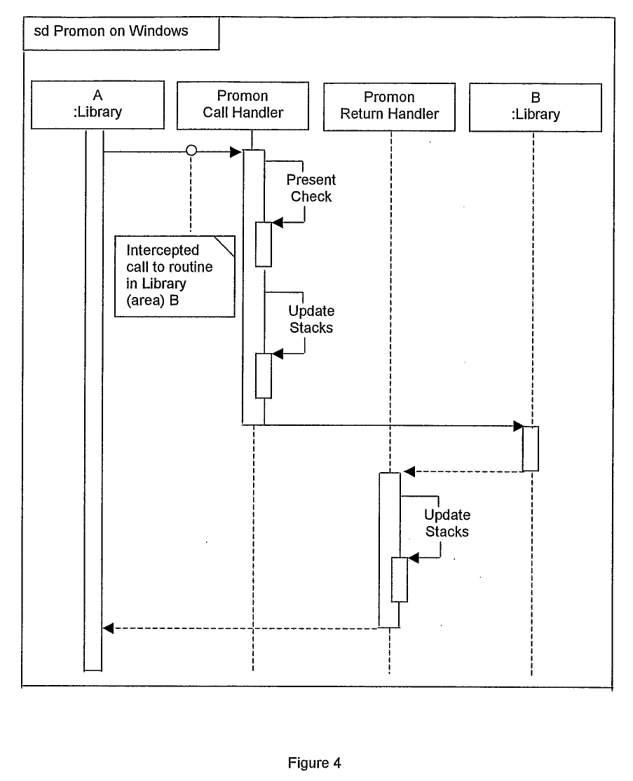

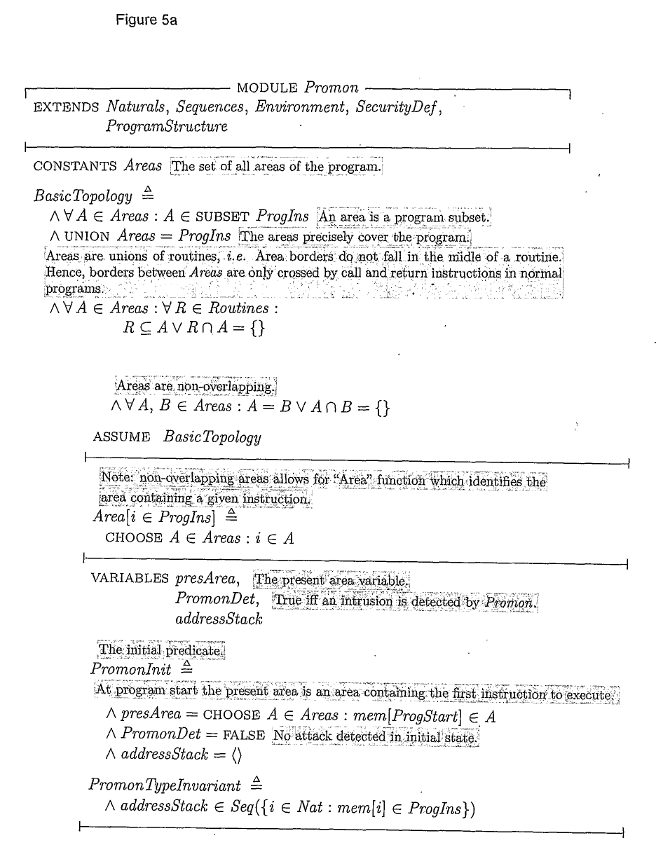

FIG. 4 is a sequence diagram of an implementation of a system in accordance with the invention on the Microsoft Windows™ platform; and

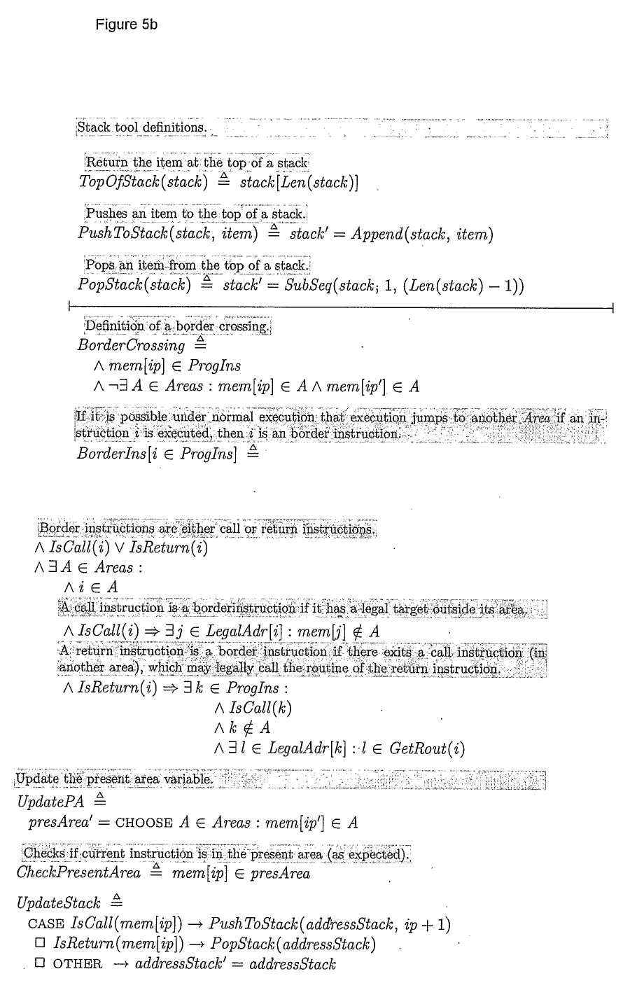

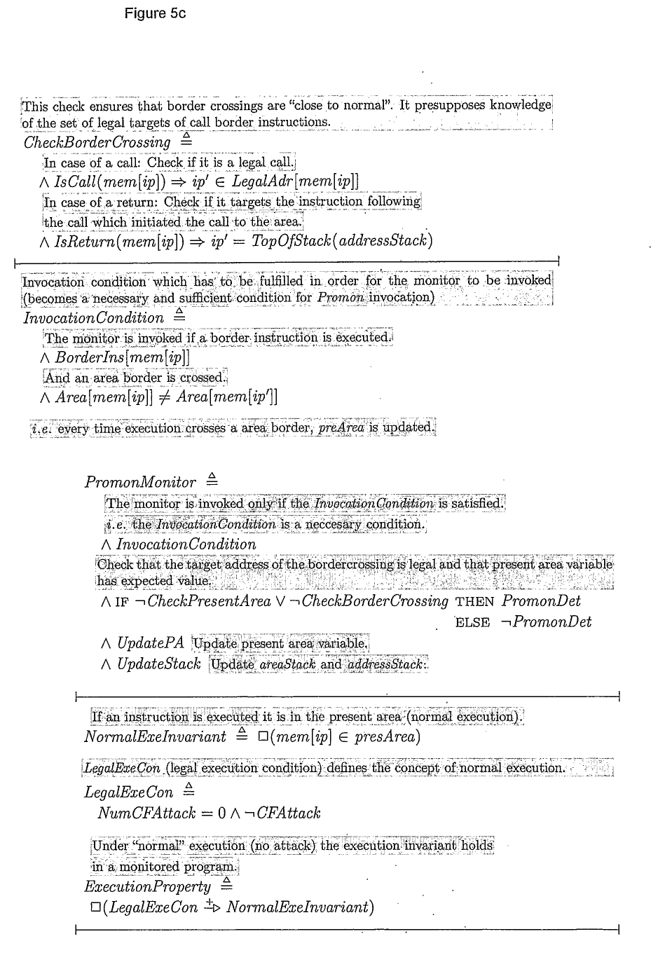

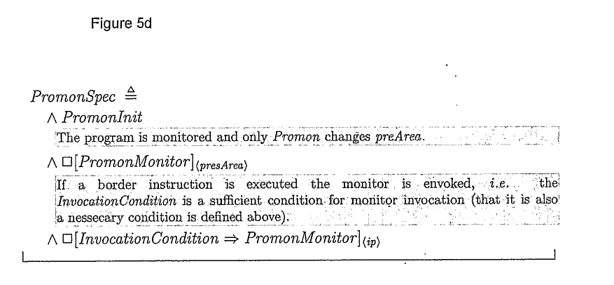

FIGS. 5a, 5b, 5c and 5d show a model of a monitoring module in accordance with the invention.

The intrusion detection monitor in accordance with the invention monitors only instructions which, during normal execution, may cause execution to branch to another area. These instructions are referred to below as border instructions. When a border instruction is executed, the monitor is invoked and if it ascertains that execution is about to enter a new area, it updates a present area variable with the ID of the new area. Hence, during normal execution the value of the present area variable will equal the ID of the area containing the instruction which is currently executed. Control flow attacks may now be detected if simple checks are carried out, when the monitor is invoked as a result of the execution of a border instruction.

In the TLA+ specification given below, the central concepts of the monitoring method are defined. The constant Areas denotes a set of program instruction areas which together completely cover the program. In this arrangement there is a simple area topology, in which areas are sets of routines, i.e. area borders follow the borders between routines. The Area operator identifies the area of a program instruction. Another simplification which is made, is that the areas are assumed to be non-overlapping. This reduces the complexity of the monitor and makes the definitions more easy to grasp. Later, more complex area topologies will be discussed.

Since area borders follow routine borders, an area border will normally only be crossed in case of execution of a call or return instruction. Thus, a normal border instruction is either a call instruction which has a legal target in another area, or a return instruction if a call instruction exist in another area, which may legally call the routine containing the return instruction.

In the model the BorderIns function identifies the program instructions which are normal border instructions. In the model the monitor is invoked when its invocation condition, InvocationCondition, is satisfied. This is the case when execution crosses an area border as a result from the execution of a border instruction:

InvokeCondition [symbol] BorderIns[mem[ip]] [symbol] Area(mem[ip])≠Area(mem[ip′])

Of course other invocation conditions are possible. Ideally the invocation condition should be a necessary and sufficient condition for the invocation of the monitor. Hit is not a sufficient condition there would be holes in the method, and if it is not a necessary condition, the monitor could be invoked in other irrelevant cases thereby increasing the performance overhead.

When the monitor is invoked it ascertains that the present area border crossing is legal. In the present model the CheckBorderCrossing predicate states whether the border crossing is legal or not. If the present instruction is a call instruction, the crossing is regarded as legal if the target address belongs to the set of legal addresses of the call instruction. Generally, such a check would require access to source code and is therefore somewhat idealized. If the present instruction is a return instruction, it is more difficult to ascertain what should be regarded as a legal crossing. Since it is desired to detect attacks on return instructions targeting instructions outside the area, a policy of “only return to instructions following a call instruction” is not sufficient. Hence, a more strict policy is needed. Since the area topology is such that an area is first entered by a call (ignoring later entering by return instruction resulting from nested calls), the return instruction should target the instruction following this call. This goal is achieved by keeping a global stack of return addresses, named addressStack in the model. This stack is updated on every area entry and exit. Hence, the return from the area should target the address on top of the address stack, a fact checked in the border crossing check.

Since the invocation condition does not cover all area border crossings, it is possible that an attack on a non-border instruction results in an unmonitored border crossing to a second area. If a normal call to a third area is reached, the border check is not sufficient to detect the attack. The border check on call instructions is passed since the call targets a legal address. However, the monitor has a concept of “present area of execution”, so that such attacks can be detected. There is therefore a present area variable, presArea, in the model. This variable is checked and updated when the monitor is invoked (by the CheckPresentArea and UpdatePA operators). This ensures a significant protection of instructions which are not directly monitored.

FIG. 1 is a state machine diagram of the main functionality of the monitor. After going through initialization, the monitor enters a ready state, waiting for a border crossing to occur, or program termination. If the border crossing fulfils the invocation condition for the monitor, an orthogonal checking state is entered. In this state the border crossing and present area checks are performed. If any of these fails, an intrusion is detected and the monitor terminates execution of the program. If both checks are passed, the monitor considers the execution legal and enters a state of updating. In this state the present area variable and the return address stack are updated. When this is done, the monitor enters the ready state again. This solution presupposes that the program is well-behaved with respect to function calls and requires that the monitor catches all deviation from normal flow of execution, e.g. stack roll back caused by exception occurrences. These problems are not addressed in the present model, but should of course be addressed in a complete implementation of the method.

If the program execution flow is normal and no control flow (CF) attack has occurred, the following invariant holds: mem[ip]εpresArea

The NormalExelnvariant predicate denotes this invariant in the model, which is set out in FIGS. 5a to 5d, and in which the monitor is called “Promon”.

Consider now a CF attack on a border instruction of an area. In FIG. 2 this situation is illustrated by a sequence diagram. The attack targets a border instruction a of an area A. If the goal of the attack is to call a routine in area B, the attacker may either call the routine directly or indirectly: An indirect call attack targeting a legal call instruction in area A is not detected and the monitor is not invoked when the border instruction a is executed. This is because no area border is crossed, and the invocation condition is consequently false. In case of a direct attack call from instruction a to a routine in area B, the monitor is invoked and the border check is carried out. If a is a call or branch instruction, the border check is not passed since as there is a CF attack and a non-legal address is targeted.

The case in which a is a return instruction is more complex. Since it is presupposed that there have been no immediate preceding calls from area A to B by stating that addressStack is initially empty, there can be no legal returns from A to B. This fact is discovered by the monitor when the border check is performed and consequently the attack is discovered in this case as well. If, on the other hand, there had previously been a call from area B to A, and the top of the address stack therefore contained an address in B, for example adr, the attack on the return instruction b would only be detected if it targeted an address different from adr. If the attack targeted address adr, it would constitute a premature exit from area A, and the only consequence would be that some instructions were not executed. This type of attack can be considered as a “short cut attack”.

It should be noted that a short cut attack could have been detected if the border check included a check of whether the return instruction belonged to the routine which was originally called from area B.

In FIG. 3, an attack on a non-border instruction in an area A is illustrated. The first alternative illustrates the case in which the attack targets a routine in the same area. These types of attack are not detected since the monitor is never invoked. Attacks targeting instructions in the same area as the attacked instruction may be called “area internal” attacks.

If the attack targets a routine in another area (B), the monitor is not invoked when the border is crossed. This is because the invocation condition is not met, since the attacked instruction in area A by assumption is a non-border instruction. Hence, the detection of the attack depends on the succeeding flow of control in area B. If a border crossing occurs as a result of the execution of a border instruction in area B, the monitor is invoked and the attack is detected when the PresentCheck is carried out. This is because the present area variable does not equal the area of the currently executed instruction.

If no border instruction in area B is reached and execution leaves the area by a non-border return instruction, the monitor is not invoked and the attack is not detected. If the return instruction had been a border instruction the monitor would have been invoked and the attack detected.

The method described above provides a significant protection level without monitoring of all CF instructions, but intrusions affecting un-monitored instructions are still detected. The only cases in which the attack is not detected is when the attacker targets a routine in B, which is not normally called from outside area B and which make no further calls to routines in B which causes border crossings, and when there is an area internal attack. Proper adjustment of the area topology, can be used to remedy these delimitations.

In safety critical areas of the program, the size of the monitored areas should be smaller. This would allow for detection of attacks which would otherwise have occurred as area internal attacks if a larger area topology had been chosen. Adjustment of the area size will also allow for detection of attack calls to the type of routines in the other delimitation. This may be achieved by dedicating one area to each such routine, for which this is relevant, thereby causing the monitor to be invoked every time the routine is called.

Of course this type of special monitoring increases performance overheads and should only be chosen for security critical routines. It is considered that no such special monitoring should be needed on the Microsoft Windows™ platform, which is considered in more detail below. This platform is very widely deployed and has been targeted frequently by control flow attacks in recent years. The embodiment below concerns the Microsoft Windows™/Intel™ platform

Previous detection mechanisms induces a significant memory overhead as a result of substantial use of code copying or code overwriting. The present method uses an execution interception layer in order to reduce the memory overhead by using minimal code overwriting, and in order to optimize implementation by close integration of the interception and detection layer.

The main objective of this implementation is to minimize performance overhead while still providing a level of protection which matches state-of-the-art detection methods.

If a simple area topology was chosen, with continuous intervals of program addresses constituting the areas for the detection method, the method could probably be implemented by extending the functionality related to virtual memory management. This solution is not considered here and instead there is considered a more easily implementable solution, in which the monitor is injected into the address space of the monitored program.

Several methods for injecting code into a process are described by Jeffrey Richter in “Programming Applications for Microsoft Windows”, Microsoft Press, fourth edition, 1999. The present method chosen is Windows Hooks which allows code to be injected into running GUI programs.

When the monitor code is injected into the program, it is necessary to establish interception functionality which ensures that the monitor is invoked at suitable times, such that execution can be monitored. There is thus an interception mechanism which intercepts the normal execution when a library border is crossed, i.e. the libraries of the program constitute the areas of the monitoring method. One advantage of the interception method is that it does not require code copying or code overwriting. Another advantage is that execution is only intercepted when a library border is crossed.

Richter describes how routine calls to an imported routine of a library can be intercepted by overwriting the code pointer in the IAT (import address table) of the library. The code pointer is overwritten with the address of a so called hook routine. When the hook routine is called, it pushes call parameters to the stack and calls the original routine. Unfortunately, this method requires knowledge of the type and number of input parameters of the hooked routine, and this knowledge is not normally accessible for all routines. The method also induces a significant execution overhead since it copies the input parameters to the stack before calling the hooked routine, i.e. input parameters are pushed to the stack twice for each hooked routine call.

In the present embodiment, the method described by Richter is generalized in such a way that no knowledge of input parameters are necessary and such that no extra push of parameters to the stack is performed. This makes it possible to monitor all routine calls using the IAT, which is important since the present area check is only viable if all legal area exits and entries are monitored.

In the present implementation the addresses in the IAT are overwritten with addresses to small code stubs, which redirect execution to a global monitor call handler. Each entry in the IAT's is assigned a unique code stub, which contains an ID of the library, i.e. area, to which the IAT belongs, as well as the ID of the library containing the imported routine and the address of this routine. The IAT as well as the monitor stubs are normally write protected. This ensures that an intercepted call is directed to the start address of an imported routine, and consequently that the call constitutes a legal border crossing (in a weak sense of the word).

The checking of a border crossing described previously is superfluous, since it is implicitly performed when the monitor forces the intercepted call to target an imported, legal, routine. The call handler consequently only performs the present area check.

If a vulnerable instruction in the present area is attacked and targets one of the code stubs which does not belong to that area, the attack is detected when the monitor performs the present area check and discovers that the area ID of the stub does not equal the ID of the present area. On the other hand, if the attack targets a code stub belonging to the present area, the attack is not detected. Consequently, an attack targeting imported routines (code stubs) of the present area passes un-detected.

When the call handler intercepts a call, it pushes the address of the monitor return handler routine to the runtime stack, before it directs execution to the original routine. The pushed address acts as a return address in such a way that when the original routine returns, it returns to the start of the global monitor return handler. After the execution of a return instruction (on the Intel™ platform) there is no indication in the program state of which return instruction was just executed. Consequently, there is no sense in performing a present check in the return handler, which therefore simply updates the present area variable and redirects execution to the instruction following the last unreturned intercepted call.

In FIG. 4 the interception of an area border crossing is illustrated, in an embodiment exemplifying implementation on the Microsoft Windows platform. A call from library A to library B is intercepted by the call handler, which performs the present check by comparing the ID of the present area to the ID of the code stub which intercepted the call. The call handler updates the address stack (saving the return address of the intercepted call) and pushes the ID of the present area to the area stack. Since there is no separate present area variable, this serves as an implicit updating of the present area value. In this sense the present area variable of the previous embodiment is derived from the area stack, i.e. it equals the value at the top of the area stack and is updated by operation on the area stack. In the discussion of the present embodiment, when a reference to the present area variable is encountered, it should be understood as a derived variable.

After updating of the area stack, execution is directed to the original target routine. When this routine has finished executing, the return handler is invoked. The return handler updates the present area variable with the value saved on the area stack and updates the address stack and area stack by popping the top item on both stacks. Execution is then redirected to the address which were popped off the address stack, i.e. the address of instruction following the last unreturned intercepted call.

The use of the address stack and area stack introduces one issue concerning threads. In the above description, single threaded execution is silently assumed. In a multi-threaded environment each thread must have assigned its own address stack, area stack and present area variable. If each thread switch were intercepted at the OS level, these variables could be effectively updated before execution of another thread was resumed.

In the present implementation, the thread functionality is implemented as part of the call handler and return handler. Before they perform other tasks these handlers check whether a thread context switch has occurred. This more simple implementation has a consequence that the thread checks constitute a significant part of the execution overhead induced by the monitor. This issue is therefore a target for future optimization.

Consideration will now be given to cases in which execution follows a pattern not covered by the standard model discussed earlier. These special cases have to be dealt with in a complete implementation of the monitor method.

Non-standard Interface Calls need to be considered. Routine calls using the standard library interface are not the only way in which a routine call may cross a library border though. The Windows™ OS provides another possibility for calling an exported routine of a library.

A reference (address) to an exported routine may be obtained by calling the GetProcAddress routine with a parameter identifying the library containing the routine, and with a parameter containing the name of the routine. The GetProcAddress routine then returns the address of the exported routine. This address may later be used in a direct call to the routine; a call which consequently does not use the import address table and which is therefore not intercepted by the method described above.

This problem can be solved by intercepting all calls to the GetProcAddress routine and by replacing the address returned by the routine with the address of a code stub similar to those described above. This ensures that all subsequent calls which use this reference are intercepted by the monitor. Unfortunately, calls are not intercepted if they use a reference obtained by calls made to the GetProcAddress routine prior to the injection of the monitor mechanism. This problem could be solved by injecting the mechanism at the time the process is created.

The combination of interception of calls using the TAT and calls using the GetProcAddress references, is in many cases sufficient for intercepting all calls crossing library borders. All cases are not covered though, since some libraries use other means for resolving references for calls to other libraries. One such example is a library using Microsoft's Component Object Model (COM). COM resolves routine (or object) references without using the above mentioned methods. In. Spying on COM objects. Windows Developer Magazine, July 1999, Dmitri Leman describes a method for intercepting calls to COM objects. Alternatively, the problem could be solved by not intercepting any calls to libraries providing COM interfaces. In terms of monitor areas, this would mean that a library providing a COM interface would be part of every area containing libraries importing the COM interface, i.e. the monitor areas would become overlapping.

Callback routines will now be considered. Windows™ has an event driven architecture, in which events such as a mouse click are captured by the OS and translated into so called messages. Each thread has a message queue for each type of message and has special routines registered to handle the various messages. These special routines, which are normally referred to as callback routines, are called by the OS which interrupts the normal execution of the thread and calls a callback routine.

The callback routine is executed in the context of the interrupted thread, resulting in an abnormal flow of control. The monitor deals with this by intercepting the user mode OS routines dispatching the callbacks. When a callback is intercepted, the monitor identifies the location of the callback routine and update the present area value and address stack accordingly. Invocation of the callback dispatchers are intercepted by overwriting the start of the dispatcher routines with a jump to the monitor callback handler.

This use of code overwriting is very limited, since only a couple of callback dispatchers exist in the Windows™ OS. On the Windows platform callbacks are most commonly used in relation to user interface interaction, but also for dealing with asynchronous routine calls.

Exceptions also need to be considered. An exception can be raised by the CPU (known as a hardware exception) due to invalid memory access, division by 0, or by the application itself or the operating system. The last type is known as a software exception. The application can raise a self defined exception by calling the RaiseException routine in the Win32 API. This routine is quite special in the sense that it does not return at all. The reason is that when an exception occurs (hardware or software), the OS takes over and starts a search for so called exception handlers. If an exception handler is found, the OS cleans up the stack (unwinding) and transfers control to the exception handler, which is the point from which the program continues execution. Hence, the execution does not return to the instruction following the call to RaiseException but continues at the first exception handler accepting to handle the exception.

In a full implementation of the monitor, exception handling should be intercepted. The monitor should parallel the roll back of the runtime stack with similar roll back of the present area and address stack. Otherwise false alarms could be the result.

If calls to RaiseException are not monitored, exceptions will not constitute a problem (in the form of a false alarm) if the exception is handled “immediately” by an exception handler in the same area as the exception occurred.

The native API is an interface that the part of the OS which runs in supervisor mode exposes to the part of the OS which runs in user mode. The transition from user mode to supervisor mode is not carried out like a normal function call, and instead software interrupts are used. When such an interrupt instruction is executed in user mode, the interrupt is handled by a so called system service dispatcher (David A. Solomon and Mark E. Russinovich. Inside Microsoft Windows 2000. Microsoft Press, fourth edition, 2000). The system service dispatcher identifies the system service function which should be called and executes this. When the system service function has finished executing, execution returns to user mode.

Attempts to evade detection by exploiting this could be countered by interception of execution of the system service dispatcher. The monitor could then perform a check if the system service function about to be executed could be legally called from the present area of execution. The present area of execution should be either Ntdll.dll or the Gdi32.dll.

Setjmp and longjmp are part of standard C and act, in a sense, as an inter-function

“Goto”. The two functions make it possible to jump directly back to a place in code, even through nested function calls without going through function returns. If such an inter-function jump is performed, the stack is unwounded accordingly. Thus, the monitor must intercept such jumps and perform a parallel unwinding of the monitor stacks.

Another possibility for breaking out of the normal flow of execution is by calling the SetThreadContext function of the Win32 API. This function can be used by the program to continue execution for a specific thread from an arbitrary point. This is very rarely used and is provided in order to help debuggers. In a complete implementation of the monitor, calls to this function should be intercepted.

By implementing a more complex area topology, if necessary creating artificial areas, performance overhead may be further reduced without significantly changing the protection level. The focus is on attack calls aiming at changing the system state, which is only possible by calls to the OS. Routine calls which only change the local state of the program are therefore of less significance in this perspective. Without access to source code it is difficult, in general, to identify all routines which only result in local change when executed. A small analyzing tool can be used which identifies routines performing no calls to other routines and no calls (software interrupts) to the OS kernel. These routines are guaranteed to change only program state and may therefore be ignored by the monitor. without significantly changing the protection level. These routines are referred to as “simple routines”.

The simple routines can be identified by performing analysis of assembler code of the libraries. With this optimizing in place, the topology of the monitor areas becomes more complex. A simple routine will now belong to every area containing a call to the routine, i.e. the areas may now be overlapping.

There is a significant improvement in the performance overhead of programs in which a large ratio of routine calls are to simple routines. This is because these routines are often very short and consequently the overhead induced by the monitor mechanism dominates execution.

The concept of simple routines could be further generalized by introducing a distinction between security relevant and irrelevant system states. For example, system states related to GUI functionality could be regarded as security irrelevant, and consequently calls related to change in GUI state could be ignored, resulting in further optimization of the implementation.

In the above described embodiments of the invention, intrusion is detected by a piece of software code for the monitoring mechanism, which is injected into the address space of the program. Thus, since the monitoring mechanism is part of the program it is possible that monitor itself may be attacked. In order to avoid this, the following is done.

Firstly, the code part of the monitor is write-protected, and thus the only way to attack this part of the monitor would be to remove the write protection and then overwrite the code. Consequently, operative system calls which may change the protection attributes are properly checked by the monitor before they are allowed.

Secondly, regarding the data part of the monitor, in one embodiment this is removed from the program. This is done by moving this part of the monitor to the operating system level, i.e. to protected/supervisor mode, making it inaccessible from the program. Each time the monitor is invoked, a switch to protected mode is performed. In protected mode the necessary checks are performed (variables are updated etc.) and then control is switched back to the program. Some static write-protected data could remain part of the program.

In another embodiment, the data part of the monitor is kept within the program but made inaccessible. This is done by write-protecting the data. Before the monitor variables are manipulated, the write-protection is turned off, and is then turned back on again when variable manipulation is finished. However, this requires several calls to the write protection functionality each time monitor is invoked, and thus increases the execution time overhead.

In yet another embodiment, the data part of the monitor is made inaccessible by adjusting operating system functionality related to virtual memory management. Use is made of the page fault handling system of the OS. Generally, the content of a program is either stored in RAM or on a disk. When a running program tries to access an address not currently in RAM, a page fault occurs. This page fault is handled by a “page fault handler” in the OS. The page fault handler swaps the required part of the memory from disk to RAM so that execution can continue. In the present embodiment, this functionality is extended by manipulating the settings of the virtual memory, in such a way that it looks as if the monitor is not currently stored in RAM. Hence, when the monitor part of the memory is about to be executed or manipulated, a page-fault occurs. Even though the monitor may actually be in RAM, it does not appear that this is the case: Thus, the extended page fault handler takes control of the execution and notices that the monitor is about to be entered.

The page fault handler checks whether the request to enter the monitor is from an unexpected part of the memory (i.e. whether it is illegal) and if it is not, execution continues within the monitor. When the monitor has finished executing, the virtual memory settings are re-set so that it appears that the monitor is not stored in RAM. Accordingly, this method ensures that the monitor is not accessed from an illegal part of the program, without an execution time penalty.

An embodiment in accordance with another aspect of the invention is based on the functionality of the processor related to memory pages. The essence of this method is also to divide a program into different areas and to subsequently monitor border crossings which occur when execution flows from one area to another. Compared to the methods in the previous embodiments, the monitoring is strengthened by not only monitoring execution of normal cross border instructions, but all border crossings (even those initiated by manipulated instructions which would not normally be cross border instructions.

There are several ways of implementing the monitoring of all border crossings. In the present embodiment there is described a method based on manipulating the protection level of memory pages by utilizing the supervisor/user protection level setting of memory pages.

Assume that execution of a program starts in area A, and that there are other areas such as B. In the original (unmonitored) program the protection level of all memory pages would have been set to “user level”, which is the default setting for Windows Programs. In accordance with the present embodiment, with program monitoring implemented, whilst area A is set to user level, the protection for other areas such as area B is set to “supervisor level”. When execution starts in area A, everything is as during normal execution. However, if a control flow instruction is executed which transfers execution to area B, to execute an instruction in area B, this will raise a protection fault because the protection level of area B is set to supervisor. Thus, the attempted border crossing has caused a protection fault. The program monitoring system has replaced the original “fault handler”, and program monitoring will now be invoked.

The program monitor checks whether the border crossing is legal, i.e. whether the control instruction from area A is a normal border instruction and the target in area B is legal. If the crossing is legal, the program monitor sets the new protection level of area B to “user” and that of area A to “supervisor”. After this is done, the program monitor allows execution continue at the targeted instruction in area B. Subsequently, the same procedure is carried out when there are cross border instructions from B to another area C, C to D and so forth.

It should be noted that if the cross border instruction in area A was a function call, the program monitor would update its stack (of the thread) with an identifier of the instruction or the next instruction in area A. Thus, when the function in Area B returns to area A, the program monitor will know that (if legal) the return is supposed to target instruction the appropriate instruction in area A.

If, on the other hand, the original cross border instruction in area A is a read instruction (a “non control flow instruction”) reading data situated in area B, the program monitor handles the situation differently. In this case, the program monitor temporarily lowers the protection level of area B to “user”, thereby allowing the read instruction to carry out its task. When the read instruction has completed its task, the program monitor restores the protection level of area B to “supervisor”, before letting execution continue in area A, with execution of the next instruction A6.

In recognized data areas such as the stack and heap, it is possible to keep the original protection level (“user”) while still detecting injected code attacks in these areas. For example, if malicious code is injected on the stack and this code performs a call to code outside the present area (which therefore has protection level set to “supervisor”), a protection fault will occur and the attack will be detected. Hence, only injected code targeting instructions within the “present” area of execution will pass undetected. In most cases this solution will provide a high level of protection.

Keeping the protection level of recognized data areas set to “user”, results in two main policies concerning control flow from a “data area” (not explicitly part of the present area) to a “new area”:

a) Either this kind of border crossing is completely forbidden (as described in the preceding paragraph), or
b) Such border crossings are allowed if they target a function “imported” by the present area.

On the Windows platform, a natural choice to define an areas is to use the program modules (DLL's). If such an area topology is chosen, the “b” policy mentioned above would never be violated by standard programs. Furthermore, since in general one does not expect calls to other modules from self-modifying code, the stronger “a” policy may be suitable in many cases.

The implementation of program monitoring using the memory based system of the present embodiment, has the following main characteristics:

a) All border crossings are monitored.
b) Existing code attacks are detected (without the use of randomisation, as is necessary in some prior art systems).
c) Injected code attacks are detected (without enforcing non-execution restrictions in data areas).
d) Since no randomisation is used, this method may protect programs with “non-relocatable” code.
e) Since execution is (to a certain extent) allowed within data-areas, this method may protect programs using self-modifying code.

If all of the program monitor functionality is implemented as part of the “fault handler”, the private variables of the program monitor will be protected from malicious manipulation.

In certain embodiments of the invention the validity of a cross border instruction may be determined having regard to the nature of the instruction itself and/or whether it should be a cross border instruction and/or the target address. In some embodiments of the invention a cross border instruction will be an instruction whose pointer targets an instruction in a new area. In some embodiments a cross border instruction will be an instruction which reads data from across a border. In some embodiments of the invention, a recognised data area, such as the stack, is not considered as one of the discrete program areas and thus data manipulation (read/write) within these areas will not cause a fault; neither will execution of (self-modifying) code within such areas.

1. A method of detecting intrusion in a program running on a data processing system, the program having a number of areas and including normal cross border instructions which, during normal execution, cause program execution to move from a source area containing the cross border instruction to a target area; wherein:
(a) there is associated with each cross border instruction data indicating the source area of the cross border instruction;
(b) an intrusion detection system monitors the execution of cross border instructions;
(c) data is stored identifying a current execution area, being the target area of the most recently monitored cross-border instruction which was executed so that program execution was transferred to its target area;
(d) when a cross border instruction is executed, the intrusion detection system determines whether the source area of the instruction matches the current execution area.

2. A method as claimed in claim 1, wherein the intrusion detection system does not monitor program control flow instructions which are not cross border instructions.

3. A method as claimed in claim 1, wherein the intrusion detection system determines whether the target address of a cross border instruction is a legal target.

4. A method as claimed in claim 3, wherein the intrusion detection system only determines whether the source area of the instruction matches the current execution area, if the target address is a legal target.

5. A method as claimed in claim 1, wherein an identifier in respect of the current execution area is stored.

6. A method as claimed in claim 1, wherein the current execution area is identified as the top address on a return address stack.

7. A method as claimed in claim 1, wherein the areas include libraries of the program.

8. A method as claimed in claim 1 wherein the areas include artificially created areas.

9. A method as claimed in claim 1 wherein each cross border instruction is provided with a code stub indicating the source area of the instruction.

10. Data processing apparatus for executing a computer program, the program having a number of areas and including normal cross border instructions which, during normal execution, cause program execution to move from a source area containing the cross border instruction to a target area; wherein the apparatus is configured to provide an intrusion detection system for monitoring the execution of the cross border instructions, in which:
(a) there is associated with each normal cross border instruction data indicating the source area of the cross border instruction;
(b) data is stored identifying a current execution area, being the target area of the most recently monitored cross-border instruction which was executed so that program execution was transferred to its target area;
(c) when a cross border instruction is executed, the intrusion detection system determines whether the source area of the instruction matches the current execution area.

11. A software product containing instructions which when run on data processing apparatus executing a computer program having a number of areas and including normal cross border instructions which, during normal execution, cause program execution to move from a source area containing the cross border instruction to a target area, will cause the apparatus to be configured to provide an intrusion detection system for monitoring the execution of the cross border instructions, in which:
(a) there is associated with each cross border instruction data indicating the source area of the cross border instruction;
(b) data is stored identifying a current execution area, being the target area of the most recently monitored cross-border instruction which was executed so that program execution was transferred to its target area;
(c) when a cross border instruction is executed, the intrusion detection system determines whether the source area of the instruction matches the current execution area.

12. A method of modifying a computer program having a number of areas and including normal cross border instructions which, during normal execution, cause program execution to move from a source area containing the cross border instruction to a target area, the method including the step of modifying the computer program so that when the program is run on data processing apparatus the program will cause the apparatus to be configured to provide an intrusion detection system for monitoring the execution of the cross border instructions, in which:
(a) there is associated with each cross border instruction data indicating the source area of the cross border instruction;
(b) data is stored identifying a current execution area, being the target area of the most recently monitored cross-border instruction which was executed so that program execution was transferred to its target area;
(c) when a cross border instruction is executed, the intrusion detection system determines whether the source area of the instruction matches the current execution area.

13. A software product containing instructions which when run on data processing apparatus will cause the apparatus to execute a computer program having a number of areas and including normal cross border instructions which, during normal execution, cause program execution to move from a source area containing the cross border instruction to a target area, the software product instructions being such as to further configure the apparatus to provide an intrusion detection system for monitoring the execution of the cross border instructions, in which:
(a) there is associated with each cross border instruction data indicating the source area of the cross border instruction;
(b) data is stored identifying a current execution area, being the target area of the most recently monitored cross-border instruction which was executed so that program execution was transferred to its target area;
(c) when a cross border instruction is executed, the intrusion detection system determines whether the source area of the instruction matches the current execution area.

14. A method of detecting intrusion in a program executing on data processing means, the program having a number of defined areas and including cross border instructions which cause execution to branch from a source area containing the cross border instruction to a target area; wherein the method comprises the step of determining whether execution of the program is in an area consistent with normal execution of the program.

15. A method as claimed in claim 14, wherein the method comprises the step of determining whether the source area of a cross border instruction is the expected area of execution of the program.

16. A method as claimed in claim 14, wherein the method comprises the step of determining whether the target address of a cross border instruction is a legal address.

17. A method of detecting intrusion in a program running on a data processing system, the program having a number of discrete program areas and comprising, in each discrete program area, instructions including at least one cross border instruction which, during execution, causes program execution to move from a source discrete program area containing the cross border instruction to a target discrete program area; wherein:
(b) a currently active discrete program area of the program is set so that memory pages have a level of protection which will allow execution within that currently active area without generation of a fault;
(b) other discrete program areas of the program are set so that memory pages have a level of protection which will generate a fault if there is an attempt to access those other areas;
(c) when a cross border instruction is encountered in the currently active area of the program, seeking to move program execution to a target in another discrete program area, the generation of the fault causes an intrusion detection system to determine whether the cross border instruction is valid.

18. A method as claimed in claim 17, wherein if the cross border instruction is valid, the currently active discrete program area of the program is set so that memory pages have a level of protection which will generate a fault if there is an attempt to access that area; and the other discrete program area containing the target of the cross border instruction is set so that memory pages have a level of protection which will allow execution within that other area without generation of a fault.

19. A method as claimed in claim 17, wherein if a cross border instruction is not a control flow instruction but is seeking to read data in another discrete program area, the other discrete program area containing the target of the cross border instruction is set temporarily so that memory pages have a level of protection which will allow reading of data within that other area without generation of a fault; and after reading of the data that other program area is set so that memory pages have a level of protection which will generate a fault if there is an attempt to access those other areas.

20. A method of detecting intrusion in a program running on a data processing system, the program having a number of discrete program areas and comprising, in each discrete program area, control flow instructions including at least one cross border instruction which, during execution, causes program execution to move from a source discrete program area containing the cross border instruction to a target discrete program area; wherein an intrusion detection system monitors only control flow instructions which are cross border instructions.
